(19) United States
(12) Patent Application Publication
(10) Pub. No.: US 2004/0074703 A1
(43) Pub. Date: Apr. 22, 2004

(54) Elevating drive apparatus for elevator

(75) Inventor: Hiroyuki Miyoshi, Mie (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Teijin Seiki Co., Ltd.

(21) Appl. No.: 10/659,191

(22) Filed: Sep. 10, 2003

(30) Foreign Application Priority Data
Oct. 18, 2002 (JP) P2002-303842

(51) Int. Cl. B66B 1/00

(52) U.S. Cl. 187/277

(57) ABSTRACT

The almost rectangular cutout portion (55) penetrating in the axial direction is formed in an outer edge portion (upper edge portion) of the fixed member (12), and a part of the brake device (58), to be in detail, the movable body (65) is accommodated in the cutout portion (55). Therefore, the fixed member (12) and the movable body (65) of the brake device (58) overlap on each other, and the length of a portion in the periphery of the brake device (58) is shortened, so that the size of the entire elevating drive apparatus (11) can be reduced.

The present application is based on Japanese Patent Application No. 2002-303842, the entire contents of which are incorporated herein by reference.

### BACKGROUND OF THE INVENTION

1. Field of the Invention

The present invention relates to an elevating drive apparatus for an elevator by which a cage of the elevator is moved upward and downward.

2. Related Art

A conventional elevating drive apparatus for an elevator is disclosed, for example, in Japanese Patent No. 2647745 described above. This conventional elevating drive apparatus for an elevator includes: a fixed member; a sheave pivotally supported by the fixed member, around which a rope connected to a cage of the elevator is wound; a drive motor supported by the fixed member, for rotating the sheave when the drive motor gives driving torque to the sheave; and a brake device for giving a braking force to the sheave, arranged outside the sheave in the radial direction.

This conventional elevating drive apparatus for an elevator is composed as follows. The fixed member includes: a stator disk; an attaching bracket forming an extension of the stator disk; a bar distantly arranged on one side of the stator disk in the axial direction, attached to the stator disk; and clamps respectively attached to the attaching bracket and the bar, wherein the other end portion of the brake device in the axial direction is floatingly supported by a clamp attached to the attaching bracket, and one end of the brake device in the axial direction is floatingly supported by a clamp attached to the bar.

However, in the above conventional elevating drive apparatus for an elevator, the following problems may be encountered. Since the attaching bracket and the clamp are arranged on the other side of the brake device in the axial direction and the bar and the clamp are arranged on one side of the brake device in the axial direction, the length of the periphery of the brake device in the axial direction is increased. As a result, the size of the entire elevating drive apparatus for an elevator is increased.

### SUMMARY OF THE INVENTION

An object of the present invention is to provide an elevating drive apparatus for an elevator, the entire size of which can be reduced when the length of the periphery of the brake device in the axial direction is shortened.

(1) The above object can be accomplished by an elevating drive apparatus for an elevator comprising: a plate-like fixed member; a sheave pivotally supported by the fixed member, around which a rope connected to a cage of the elevator is wound; a drive motor supported by the fixed member, for rotating the sheave when the drive motor gives driving torque to the sheave; and a brake device for giving a braking force to the sheave, attached to the fixed member under the condition that the brake device is arranged outside the sheave in the radial direction, wherein a cutout portion is formed in an outer periphery of the fixed member and a part of the brake device is accommodated in the cutout portion.

In the present invention, the cutout portion is formed in the outer peripheral portion of the fixed member, and a part of the brake device is accommodated in the cutout portion. Therefore, the fixed member and a part of the brake device overlap on each other, and the length of the periphery of the brake device in the axial direction is shortened. Due to the foregoing, the size of the entire elevating drive apparatus can be reduced.

(2) In the elevating drive apparatus, both end portions of the brake device in a circumferential direction thereof may be fastened to protrusions of the fixed member respectively formed on both sides of the cutout portion. According to such the constitution, it is possible to suppress the bending moment generated by the reaction force of the braking force compared with the conventional constitution. Therefore, the brake device can be strongly attached to the fixed member.

(3) Further, in the present invention, fastening positions, at which both end portions of the brake device in the circumferential direction are fastened to the protrusions of the fixed member, may be arranged on a common plane perpendicular to a driving axis of the elevating drive apparatus. Compared with the conventional case in which the fastening position is distant in the axial direction, the size of the entire device can be reduced in the axial direction of the drive apparatus.

### BRIEF DESCRIPTION OF THE DRAWINGS

FIG. 1 is a front view showing an embodiment of the present invention; and

FIG. 2 is a sectional view taken on line I-I in FIG. 1.

### DETAILED DESCRIPTION OF THE PREFERRED EMBODIMENTS

Referring to the drawings, an embodiment of the present invention will be explained as follows.

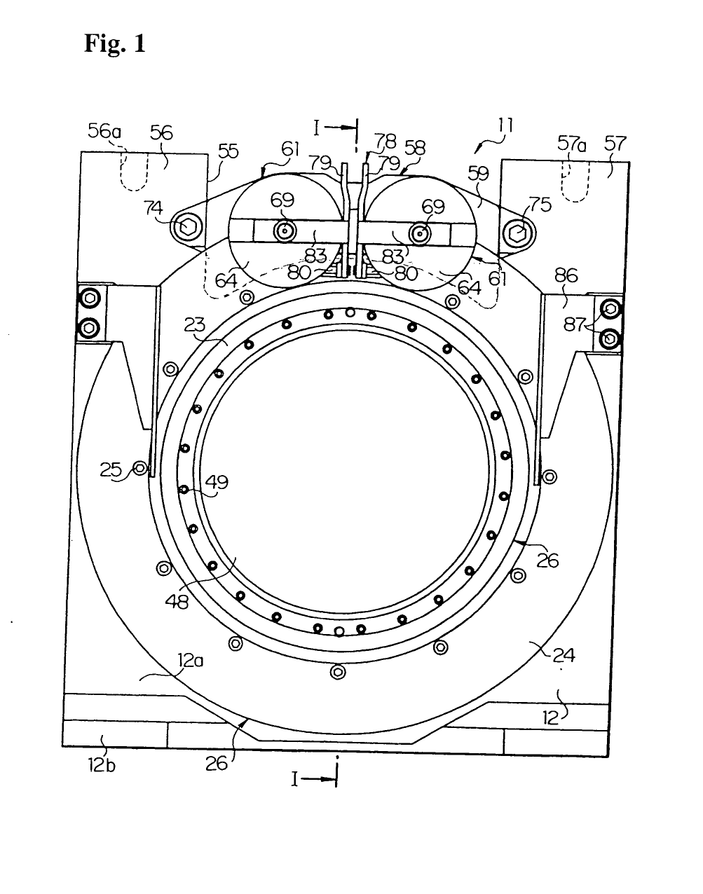

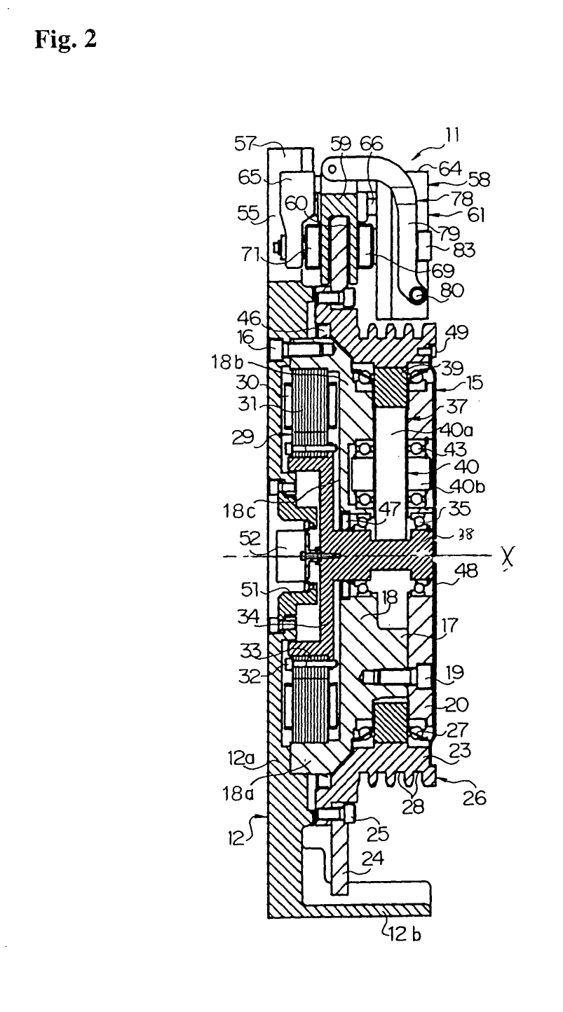

In FIGS. 1 and 2, reference numeral 11 is an elevating drive apparatus for an elevator used for elevating a cage of the elevator not shown in the drawing. This elevating drive apparatus 11 includes a fixed member 12 attached to an attaching beam (not shown) arranged in an elevator shaft. The fixed member 12 has a rectangular plate-like shape that is elected perpendicularly from an attachment wall. To be in more detail, this fixed member 12 includes: a flat plate-like body portion 12a; and a reinforcing rib 12b extending from a lower end portion of the body portion 12a to one side.

Reference numeral 15 is a support member fixed to one side of the fixed member 12 (the body portion 12a) by a plurality of bolts 16. A profile of this support member 15 is a substantial cylinder having a bottom portion. This support member 15 includes: the other side support body 18 in which a plurality of pillar portions 17 extending to one side are formed on one side; and a flange-shaped one side support body 20 arranged on one side of the other side support body 18 under the condition that it comes into contact with one end face of the pillar portion 17, fixed to the pillar portion 17 (the other side support body 18) by a plurality of bolts 19.

Reference numeral 23 is a substantially cylindrical sheave body arranged so as to cover the support member 15 from the outside in the radial direction. In the other end portion of this sheave body 23, the flange-shaped disk brake 24 is externally engaged and fixed so as to be contiguous to it by the bolts 25. The sheave body 23 and the disk brake 24 compose the sheave 26 as a whole. Alternatively, the sheave body 23 and the brake disk may be integrally formed with a single member. A pair of bearings 27 are arranged between the inner circumference of the sheave body 23 and the outer circumference of the one side support body 18, 20. By the above structure, the sheave 26 is pivotally supported by the fixed member 12 via the supporting member 15 and the bearings 27 described before. On the outer circumference of this sheave body 23, there are provided a plurality of circumferential grooves 28 around which a rope connected to a cage (not shown) is wound. By the above structure, when the sheave 26 is rotated and the rope runs in the longitudinal direction, the cage is moved upward and downward. The rope wound around the circumferential grooves 28 is extended upward or downward.

Reference numeral 29 is a drive motor for rotating the sheave 26 when a rotational drive force is given to the sheave 26. This drive motor 29 includes: a stator 31 having a coil 30 attached to the inner circumference of a cylindrical portion 18a, which extends from the circumferential part of a disk portion 18b in the axial direction of the drive motor 29 in the other side support body 18; and a rotor 34 arranged inside the stator 31 in the radial direction, with which an input shaft of a speed reducer described later is integrated, having a permanent magnet 33 attached to the outer circumference by bolts 32. An input shaft of the speed reducer is supported by the support member 15 via a pair of bearings 35 arranged distant in the axial direction, to be more specific, an input shaft 38 of the speed reducer 37 is pivotally supported by the one side support body 18, 20 on the other side. As a result, the drive motor 29 described before is supported by the fixed member 12 via the support member 15. The stator 31 is opposed to a side face 18c defined on a side facing to the motor 29 in the disk portion 18b of the other side support body 18. Namely, major part of the stator 31 is disposed in an inner space defined by the disk portion 18b and a cylindrical portion 18a.

Reference numeral 37 is a speed reducer arranged on one side of the drive motor 29 and inside the sheave body 23 in the radial direction. This speed reducer 37 includes: the input shaft 38 rotatably engaged in the sheave body 23 and arranged on the same axis as that of the sheave body 23, which constitutes a driving axis X of the elevating drive apparatus; a ring-shaped cylindrical body 39 attached to the inner circumference of the sheave body 23; and a rotary body 40 arranged between the input shaft 38 and the cylindrical body 39, the outer circumference of which comes into pressure contact with the outer circumference of the input shaft 38 and the inner circumference of the cylindrical body 39. In this case, a plurality of rotary bodies 40 are arranged in the circumferential direction at regular intervals.

Each rotary body 40 is composed of a disk-shaped disk portion 40a and a shaft portion 40b, coaxially protruding from both sides of the disk portion 40a. When the bearing 43 is interposed between the shaft portion 40b and the support body 18, 20, the rotary body 40 is pivotally supported by the support member 15. When the input shaft 38 is given a driving torque from the drive motor 29 and rotated integrally with the rotor 34, this speed reducer 37 reduces the rotation of the input shaft 38 and transmits the reduced rotation to the sheave 26 when the rotary body 40 rotates while it is coming into pressure contact with the input shaft 38 and the cylindrical body 39.

The oil seal 46 is provided between the inner circumference of the other end portion of the sheave body 23 and the outer circumference of the support body 18 on the other side. This oil seal 46 prevents lubricant from leaking out and also prevents dust from getting into the speed reducer 37 from outside. Reference numeral 47 is an oil seal provided between the inner circumference of the other side support body 18 and the outer circumference of the input shaft 38. This oil seal 47 prevents lubricant of the speed reducer 37 from leaking out to the drive motor 29 side. Reference numeral 48 is a cover fixed to one end face of the sheave body 23 by a plurality of bolts 49. This cover 48 closes one end opening of the sheave body 23. A tightly closed space is formed by the oil seals 46, 47 and the cover 48. Into this tightly closed space, the aforementioned lubricant of the speed reducer 37 is enclosed.

Reference numeral 51 is a bracket attached to the central portion of the fixed member 12. A position detector 52, which is embedded inside with respect to the other end face of the fixed member 12, is attached to this bracket 51. A rotary portion of this position detector 52 is connected with the input shaft 38 so that it can be integrally rotated. By the above structure, the position detector 52 can detect a rotary speed and rotary position of the drive motor 29.

At the outer edge portion of the fixed member 12, in this case, at the upper end portion and at the central portion in the width direction, there is provided an almost rectangular cutout portion 55 (incidentally a bottom portion of the cutout portion 55 is formed in a circular shape in this embodiment) penetrating in the axial direction. As a result, on both sides of this cutout portion 55 in its width direction, there are provided rectangular protruding portions 56, 57 of the fixed member 12 which protrude upward. Reference numeral 58 is a brake device arranged outside the sheave 26 in the radial direction and a part (the movable body 65 described later) of the brake device 58 is accommodated in the cutout portion 55. This brake device 58 has a shared bracket 59 extending in the width direction of the fixed member 12. In the central portion of this shared bracket 59 in the thickness direction (the axial direction), there are provided brake grooves 60 extending in the circumferential direction in which the brake disk 24 is rotatably engaged.

To the shared bracket 59, a plurality of brake units 61, in this case, two brake units 61, which are arranged at a predetermined interval along the outer circumference of the brake disk 24, are attached. The aforementioned shared bracket 59 and brake unit 61 compose the brake device 58 as a whole. Since the cutout portion 55 is formed in an outer edge portion of the fixed member 12 and a part of the brake device 58 is accommodated in the cutout portion 55 concerned as described above, the fixed member 12 and a part of the brake device 58 overlap on each other in the axial direction. Therefore, the length of the periphery of the brake device 58 in the axial direction is shortened. Accordingly, the size of the entire elevating drive apparatus 11 can be reduced. A pair of brake bodies 64 which are main components of a brake unit 61 are arranged in a horizontal direction (left and right direction in FIG. 1), a distance between a side end of one brake body 64 to the opposite side end of the other brake body 64, constituting a width of the brake unit 61, is provided smaller than an outer diameter of the sheave 26, particularly an outer diameter of the sheave body 23. By such the construction, the rope wound and extended from the sheave body 23 can be led not only downward, but also upward without being interfered with the pair of the brake bodies 64.

The aforementioned brake unit 61 includes: the brake body 64 arranged on one side of the shared bracket 59, a spring and an electromagnet not shown being accommodated in the brake body 64; a movable body 65 arranged on the other side of the shared bracket 59; and a plurality of connecting guides 66 extending in parallel with the input shaft 38 and penetrating the shared bracket 59, connecting the brake body 64 with the movable body 65 when one end is fixed to the brake body 64 and the other end is fixed to the movable body 65. In this case, since the connecting guide 66 penetrates the shared bracket 59, while the brake body 64 and the movable body 65 are being integrally guided by the connecting guide 66, they can be moved in the axial direction, that is, in the thickness direction of the brake disk 24.

Reference numeral 69 is a brake shoe movably supported by the brake body 64 so that it can be moved in the axial direction. The other side portion of the brake shoe is inserted into a through-hole (not shown) formed in the shared bracket 59. When the above electromagnet is electrified, the brake shoe 69 is attracted to the electromagnet while compressing a spring. Therefore, the brake shoe 69 is separated from the brake disk 24. However, when the electrification of the electromagnet is shut off, an attracting force of the electromagnet is lost. Therefore, the brake shoe 69 is pressed to the other side by the spring, and the other side of the brake shoe 69 comes into pressure contact with one side of the brake disk 24.

Reference numeral 71 is a brake shoe attached to the movable body 65 while the brake shoe 71 is being kept on the same axis as that of the brake shoe 69 described before. One side portion of the brake shoe 71 is inserted into a through-hole (not shown) formed in the shared bracket 59. In this case, when an attracting force of the electromagnet is lost as described above and the brake shoe 69 comes into pressure contact with the brake disk 24 by a pressing force of the spring, the brake body 64, movable body 65, connecting guide 66 and brake shoe 71 are integrally moved to one side by the pressing force of the spring, and one side of the brake shoe 71 comes into pressure contact with the other side of the brake disk 24. As a result, the brake disk 24 is interposed between the brake shoes 69 and 71 and given a strong braking force, that is, the sheave 26 is given a strong braking force.

Both end portions of the shared bracket 59 are respectively fastened to the protruding portions 56, 57 of the fixed member 12 by the bolts 74, 75 which are members of fastening. Due to the foregoing, both end portions of the brake device 58 in the circumferential direction, that is, both end portions in the longitudinal direction are attached to the fixed member 12. When both end portions of the brake device 58 in the circumferential direction are respectively fastened to the protruding portions 56, 57 of the fixed member 12 formed on both sides of the cutout portion 55, in the case of giving a braking force to the sheave 26, an intensity of bending moment, which is generated in the brake device 58 by a reaction force of the braking force, can be suppressed as compared with the conventional structure. Therefore, it is possible to strongly attach the brake device 58 to the fixed member 12. Further, the fixing holes 56a, 57a for fixing another attaching beam and the like (not shown), which are arranged in parallel with the aforementioned attaching beam and the like, are formed. Therefore, the elevating drive apparatus 11 can be strongly attached to the attaching beam and the like (the fixed portion).

In this case, the protruding portions 56 and 57 of the fixed member 12 are located on the same plane perpendicular to the driving axis X. Therefore, the fastening positions, at which both end portions of the brake device 58 in the circumferential direction are fastened to the protruding portions 56 and 57 of the fixed member 12 by the bolts 74 and 75, are arranged on a common plane perpendicular to the axis. As a result, compared with the conventional art in which these two fastening positions are separate from each other in the axial direction, the length of the entire device can be shortened in the axial direction.

Reference numeral 78 is a manual release device. This manual release device 78 is used when the sheave 26, which is given a braking force, is manually released for the reasons of inspection and the like. The manual release device 78 has two reverse-L-shaped release levers 79. These release levers 79 are supported in such a manner that the pins 80 fixed to the brake body 64 are inserted into the lower end portions of the release levers 79, and the release levers 79 is supported by the brake body 64 so that the release levers 79 can be swung round the pins 80.

Reference numeral 83 is a strip-shaped transmission segment fixed to one end of the brake shoe 69. The transmission segment 83 comes into contact with one side of the release lever 79. In the case of manually releasing the brake that is set at the sheave 26, an upper end portion of the release lever 79 is raised upward and the release lever 79 concerned is swung round the pin 80 to one side. Due to the foregoing, the brake shoe 69 is moved to one side (the distant side from the brake disk 24) resisting a pressing force of the spring. The release lever 79, pin 80 and transmission segment 83 compose the manual release device 78 as a whole.

Reference numeral 86 represents two latch members attached to the fixed member 12 in the circumferential direction by a plurality of bolts 87. A lower end portion of each latch member 86 extends to a position close to the outer circumference of the sheave body 23. Therefore, it is possible to prevent a rope from coming off from the circumferential grooves 28 when the sheave 26 is rotated. In the case where the rope is disconnected from or rewound on the sheave body 23, the bolts 87 are disconnected and the latch member 86 is detached from the fixed member 12.

Next, operation of one embodiment of the present invention will be explained as follows.

In the case of elevating a cage of an elevator, the coil 30 of the drive motor 29 is electrified, and the rotor 34, which has a permanent magnet 33, and the input shaft 38 are integrally rotated. At the same time, the electromagnet of each brake unit 61 is electrified, and the brake shoe 69 is attracted and moved to one side resisting a force of the spring. Consequently, the brake shoe 69 is separated from the brake disk 24, so that the brake device 58 releases the drive motor 29 from braking. As a result, while the input shaft 38 is not being given a braking force from the brake device 58, rotation of the input shaft 38 is transmitted to the cylindrical body 39 and the sheave 26 via a plurality of rotary body 40 while the rotary speed is being reduced, so that the sheave 26 is rotated at a low speed. As a result, the rope wound round the circumferential grooves 28 of the sheave 26 runs and the cage is elevated.

Next, in the case of stopping elevation of the cage, electrification of the coil 30 is shut off so as to stop the drive motor 29. At the same time, electrification of the electromagnet of each brake unit 61 is shut off. Due to the foregoing, an attracting force of the electromagnet is lost, and the brake shoe 69 is pressed and moved to the other side by a resilient force of the spring, and the other side comes into pressure contact with one side of the brake disk 24. After that, by a pressing force of the spring, while the brake body 64, movable body 65, connecting guide 66 and brake shoe 71 are being integrally guided by the connecting guide 66, they are moved to one side, and one side of the brake shoe 71 comes into pressure contact with the other side of the brake disk 24. As described above, the brake disk 24 is interposed between the brake shoes 69 and 71 from both sides. Therefore, a strong braking force is given to the sheave 26, and elevation of the cage is stopped. At the same time, the cage is held at the position of stoppage even after elevation of the cage has been stopped.

In this connection, in the embodiment described above, the input shaft 38, the outer circumference of the rotary body 40 and the inner circumference of the cylindrical body 39 are formed into smooth cylindrical faces having no irregularities. However, in this present invention, external teeth may be formed on the input shaft and the outer circumference of the rotary body, and internal teeth may be formed on the inner circumference of the cylindrical body, so that these teeth can be meshed with each other. In the embodiment described before, the speed reducer 37 is arranged between the drive motor 29 and the sheave 26. However, in this present invention, the sheave may be directly driven by the drive motor.

Further, in the embodiment described above, the brake device 58 is of the disk type in which the brake disk 24 arranged in the sheave 26 is interposed between the brake shoes 69 and 71 from both sides. However, in this present invention, the brake device 58 may be of the drum type in which braking is conducted when the brake shoe is pressed against the outer circumference of the sheave. In the embodiment described above, the brake device 58 has two brake units 61. However, the number of the brake units may be one. Alternatively, the number of the brake units may be not less than three.

As explained above, according to the present invention, when the length of a portion in the periphery of the brake device in the axial direction is shortened, the size of the entire device can be reduced.

What is claimed is:

1. An elevating drive apparatus for an elevator comprising:
a plate-like fixed member;
a sheave body pivotally supported by the fixed member, around which a rope connected to a cage of the elevator is wound;
a drive motor supported by the fixed member, for rotating the sheave body when the drive motor gives driving torque to the sheave body; and
a brake device for giving a braking force to the sheave body, attached to the fixed member so as to be arranged outside the sheave body in a radial direction of the sheave body;
wherein a cutout portion is formed in an outer periphery of the fixed member and a part of the brake device is accommodated in the cutout portion.

2. An elevating drive apparatus for an elevator according to claim 1, wherein end portions of the brake device in a circumferential direction thereof are fastened to protrusions of the fixed member respectively formed on both sides of the cutout portion.

3. An elevating drive apparatus for an elevator according to claim 2, wherein fastening positions, at which both end portions of the brake device in the circumferential direction are fastened to the protrusions of the fixed member, are arranged on a common plane perpendicular to a driving axis of the elevating drive apparatus.

4. An elevating drive apparatus for an elevator according to claim 1, further comprising a brake disk so as to be extended in a radial direction with respect to a driving axis of the elevating drive apparatus,
wherein at least one brake shoe provided in the brake device is pressed to a side surface of the brake disk for providing the braking force to the sheave body.

5. An elevating drive apparatus for an elevator according to claim 4, wherein at least one pair of brake shoes is provided in the brake device and the brake disk is clamped on opposite sides thereof for providing the braking force to the sheave body.

6. An elevating drive apparatus for an elevator according to claim 4, wherein the brake disk is contiguous to the sheave body so that the sheave body and brake disk integrally rotates.

7. An elevating drive apparatus for an elevator according to claim 6, wherein the brake disk and the sheave body are integrally formed with a single member.

8. An elevating drive apparatus for an elevator according to claim 1, further comprising a support member is protruded from the fixed member and rotationally supporting the sheave body,
wherein a stator of the drive motor is disposed in a space defined in the support member.

9. An elevating drive apparatus for an elevator according to claim 1, a width of the brake device is smaller than an outer diameter of the sheave body.

10. An elevating drive apparatus for an elevator according to claim 4, wherein the brake disk is provided between the sheave body and the fixed member in the axial direction.

11. An elevating drive apparatus for an elevator according to claim 10, wherein said at least one brake shoe is provided on a side where the fixed member is provided with respect to the brake disk.

12. An elevating drive apparatus for an elevator according to claim 6, wherein the brake disk is fixed to the sheave body so as to be contiguous to each other by fixing parts.
